(19) United States
(12) Patent Application Publication
(10) Pub. No.: US 2013/0013426 A1
(43) Pub. Date: Jan. 10, 2013

(54) Timeshare Availability Broadcast System and Method

(76) Inventor: Omar J.. Cohen, Santo Domingo (DO)

(21) Appl. No.: 13/477,857

(22) Filed: May 22, 2012

Related U.S. Application Data
(60) Provisional application No. 61/505,279, filed on Jul. 7, 2011.

(51) Int. Cl. G06Q 30/02

(52) U.S. Cl. 705/14.72

(57) ABSTRACT

A computer-based method and system for managing the placement of ads about timeshare properties in worldwide publications, including the ability to post suitable property information as well as the automatic or semi-automatic ranking of preferred rental locations based on the owners and renters information and other related intrinsic information, as well as the provisioning of ancillary services based on this information.

The following documents and references are incorporated by reference in their entirety, Thibodeau (U.S. Pat. Nos. 6,671,697 and 6,839,720), Thielges at al (U.S. Pub. No. 2002/0138289), Ingraham et al (U.S. Pub. No. 2001/0037280) and Godar (U.S. Pub. No. 2007/0156429).

### FIELD OF THE INVENTION

The field of this invention is advertising and management of vacation rental properties worldwide, in particular for those perishable items such as timeshare properties. A complete system and method is disclosed for meeting both the property management's needs as well as those of the renters' in today's Internet-driven and oriented market.

### DESCRIPTION OF THE RELATED ART

For owners of property, the renting or leasing of their property while it is not being used by them is a critical function, sometimes providing very needed revenue for the continued operation of the unit. In recent times, the advertising and management of vacation rental properties worldwide has changed from a paper-based, phone-intensive function, to one driven by the Internet

Several methods are known to match buyers with sellers of various types of property. On a basic level, an individual buyer might identify a piece of property that is being offered for sale through advertisement or word of mouth, and then directly contact the seller or the seller's agent. Once contact is made, negotiations can thereafter take place. Many systems have been developed for caching rental real property information in databases, allowing for the easy search of available units, times, etc. Among others, Thibodeau (U.S. Pat. Nos. 6,671,697 and 6,839,720), Thielges at al (U.S. Pub. No. 2002/0138289) and Godar (U.S. Pub. No. 2007/0156429) [the disclosure of all being incorporated by reference in their entirety herein] describe such systems.

Timeshare properties, however, have specific needs. In many cases, the “owner” is, as the name implies, the “owner” of a slice of time at a particular property, with the general mortgage of the physical unit itself being held by a larger owner/operator. For many reasons, timeshare properties have lagged other types of properties in the development of Internet-driven offer and sale/lease technologies. Some of these reasons are contractual (owners have to obey the rules by which they themselves “own” their time-slice of the property), others are due to owner's reticence to rock the boat. In addition, humans are at heart, tribal by nature, and systems that take that into account are bound to be more successful.

What is needed in the market, is a system that will allow owners of timeshare segments of a property to manage and channel the advertisement of their property, allowing for their strengths to be replicated in the posting of their listing.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect, the invention is about a computer-based management system for routing the advertisement of a property comprising a database for managing one or more property offerings by an user with the authority to do so, an internet enabled interface that would allow said user to identify the one or more properties to be offered, the conditions for their offering and a list of locations where said advertisements may be placed to be selected by said user, an ad placement engine capable of generating and placing electronically over the Internet individual ads containing the user selected information into the one or more computer systems responsible for taking said data and generating said ads.

In another aspect, the list of locations presented to the user is automatically generated by the management system using information about the user that they have entered into the database. In yet another aspect, the list of locations presented to the user is automatically generated by the management system using information about the user that may be obtained without said information's conscious entry into the system by the user. In one aspect, the properties being managed are timeshares.

In one aspect, the invention is about a computer-based method for managing the routing of advertisements for a property comprising providing a database for managing one or more property offerings by an user with the authority to do so, providing an internet enabled interface that would allow said user to identify the one or more properties to be offered, the conditions for their offering and a list of locations where said advertisements may be placed to be selected by said user, providing an ad placement engine capable of generating and placing electronically over the Internet individual ads containing the user selected information into the one or more computer systems responsible for taking said data and generating said ads. In another aspect, the list of locations presented to the user is automatically generated by the management system using information about the user that they have entered into the database. In one aspect, the list of locations presented to the user is automatically generated by the management system using information about the user that is obtained without the user conscious entry into the system. In another aspect, the properties being managed are timeshares.

Other features and advantages of the present invention will become apparent upon examining the following detailed description of an embodiment thereof, taken in conjunction with the attached drawings.

### BRIEF DESCRIPTION OF THE DRAWINGS

FIG. 1 illustrates the various possible users of the system according to an illustrative embodiment of the invention.

FIG. 2 illustrates various system components, according to an illustrative embodiment of the invention.

FIGS. 3A to 3E illustrate various screen shots of the system, according to an illustrative embodiment of the invention.

FIG. 4 illustrates a system architecture according to an illustrative embodiment of the invention.

FIGS. 5A to 5D illustrates various screen shots of the user's screen, according to an illustrative embodiment of the invention.

The above-described and other features will be appreciated and understood by those skilled in the art from the following detailed description, drawings, and appended claims.

### DETAILED DESCRIPTION OF THE PREFERRED EMBODIMENT

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

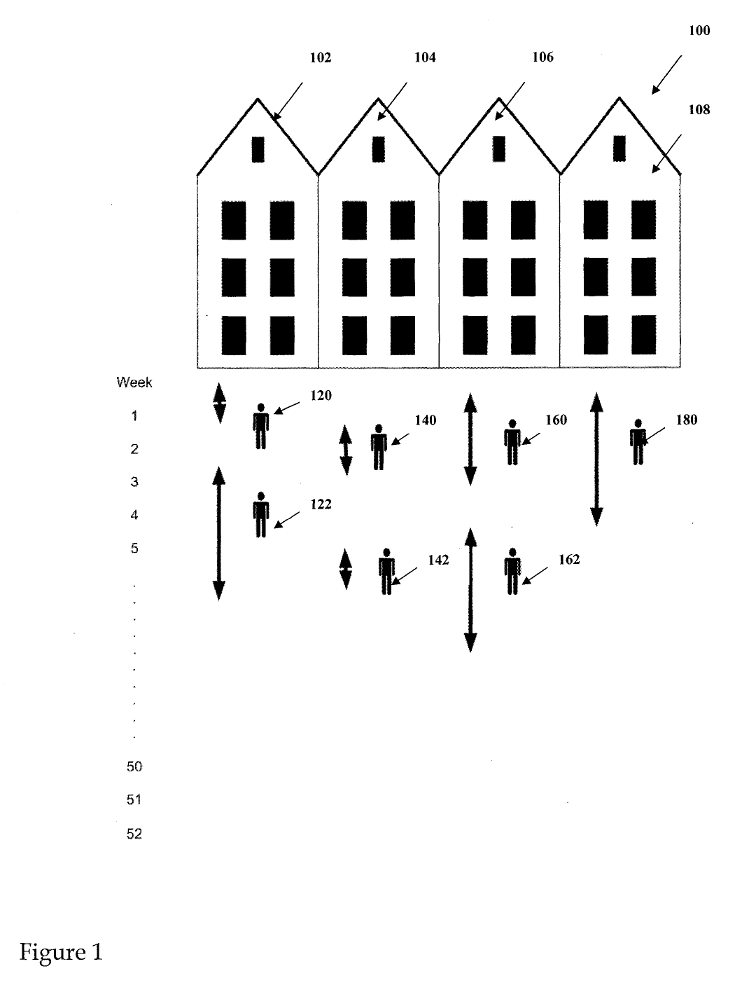

Referring to FIG. 1 the present invention involves a system and method for managing the advertising of sales/rental of properties, with particular emphasis on timeshare properties. A timeshare is a form of ownership or right to the use of a property. These properties 100 are typically resort condominium units 102, 104, 106, 108 (or unit types, say 2B, 3B, 1B rooms) in which multiple parties 120, 122, 140, 142, 160, 162, 164, 180 hold rights to the use of each specific property for a period of time.

Typically, each sharer is allotted a period of time (typically in one week increments, and almost always the same time every year) in which they may use the property. Units may be on a part-ownership or lease/ “right to use” basis, in which the sharer holds no claim to ownership of the property. As we can see, owner 120 has the rights to unit 102 during week 1 of the year. User 180 has the rights to unit 108 during the four first weeks of the year (Weeks 1-4). Note that users may have one or more units in this or any other complex.

Owners can use their usage time, rent out their owned usage, give it as a gift, donate it to a charity, exchange internally within the same resort or resort group, exchange externally with thousands of other resorts, sell either through traditional advertising, online advertising or by using a licensed broker. In recent times, operators have introduced a point system, with such a system, owners may elect to assign their usage time to a point system to be exchanged for airline tickets, hotels, travel packages, cruises, amusement park tickets.

Alternatively, owners may use portion of the points to rent part of their units, acquire more points from either the internal exchange entity or another owner to get a larger unit or more vacation time or a better location, and/or save the points from one year to another. When performing the trades above, many users go through their resort operator or exchange point entity.

However, when entitled to do so through their deed or contract, many users feel they would be able to get a better deal if they advertised all or part of their unit(s) availability on their own. To do so, the proposed system would collect information from the owner (or their empowered entity, in the case of a leasing agent), and proceed to distribute this information to the appropriate channels.

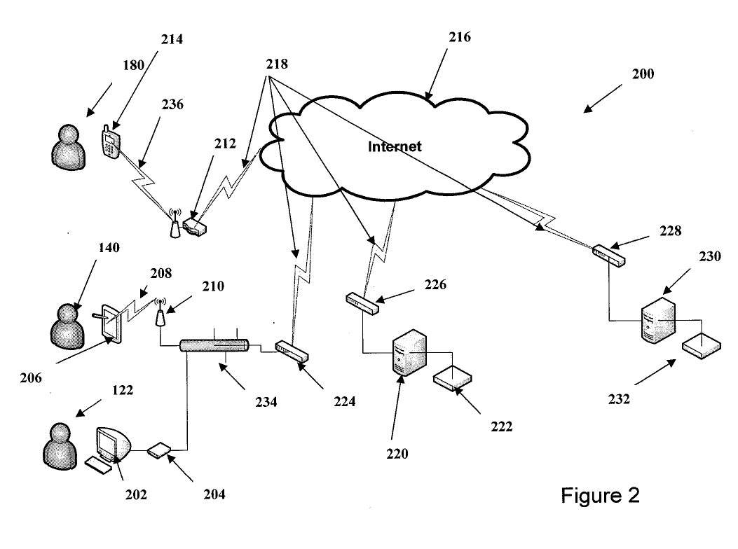

Referring to FIG. 2, in one embodiment the system 200 is an internet application operating on a resident program (or via the browser) of a user's 122 desktop computer 202 operating off a land-based Ethernet adapter 204 to a network 234 connected via DSL, Cable Modem, Fiber Optic or other such connection 224 to a network 218 that is itself connected to the Internet 216.

Or a user 140 may be working on a Tablet, notebook, net book or other portable computer 206 over a Wi-Fi, WiMax or such other wireless connection 208 to a base station 210 which is capable of then connecting via another network/adapter 234/224 to the Internet 216. In yet another embodiment, another user 180 uses a Smartphone 214 (such a an iPhone, Android or Blackberry handset) to connect over a 3G or 4G wireless network 236 to a network adapter 212 which allows a connection 218 to the Internet 216.

The user's mentioned (122, 140 and/or 180) interface via their computer's interface (be it a browser or app) over the internet 216 to one or more networked servers 220 with integrated storage capabilities 222, routers/interfaces 226 to the internet via a network connection 218.

Once the user enters the information in the database and program running on the server 220 and its storage 222, and they decide to publish their property's ad information, the system takes a number of actions. The first is to decide where to place the ads for the property. These classified publishing entities include Internet-driven sites such as search engines (Google, Bing, Yahoo and others), as well as regional/local internet classified entities (Craigslist, Capelinks, etc.), message boards, web-sites and Regional/local papers around the world.

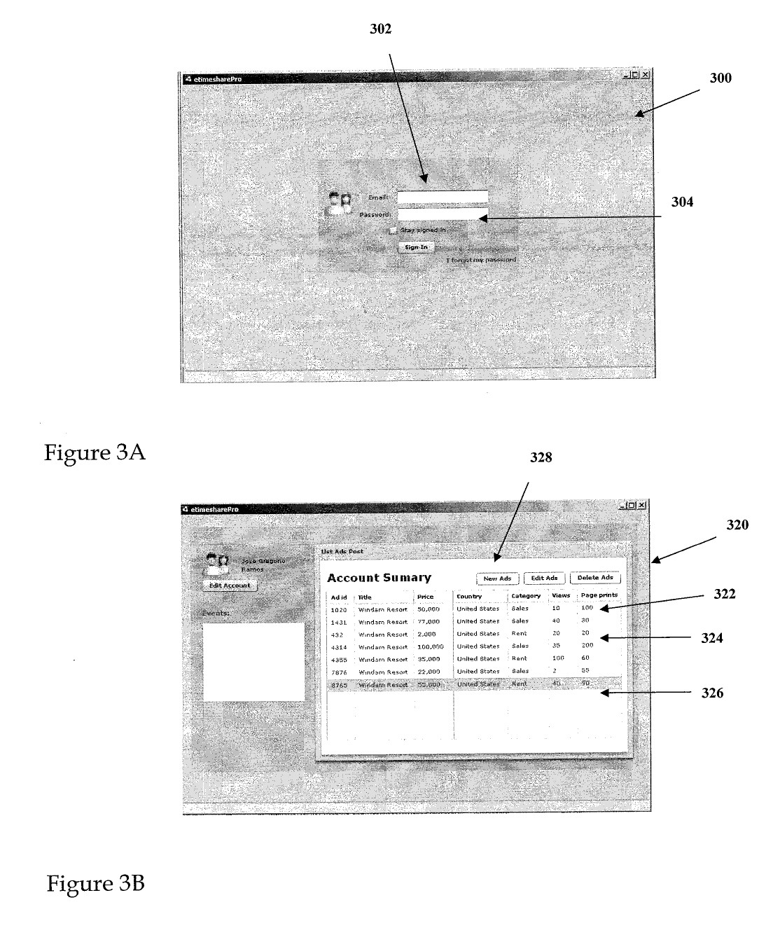

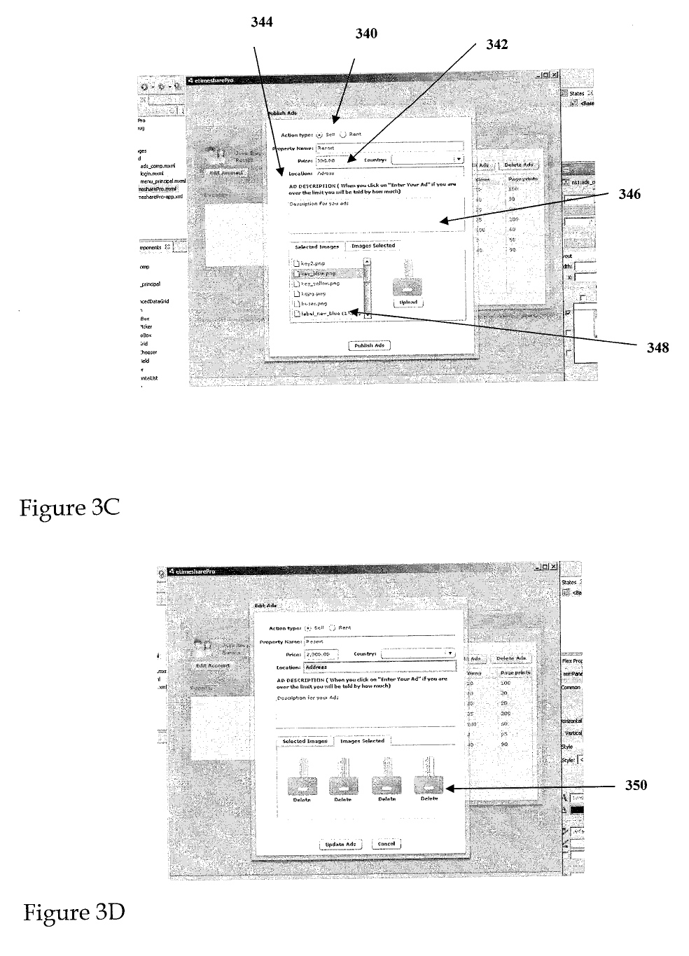

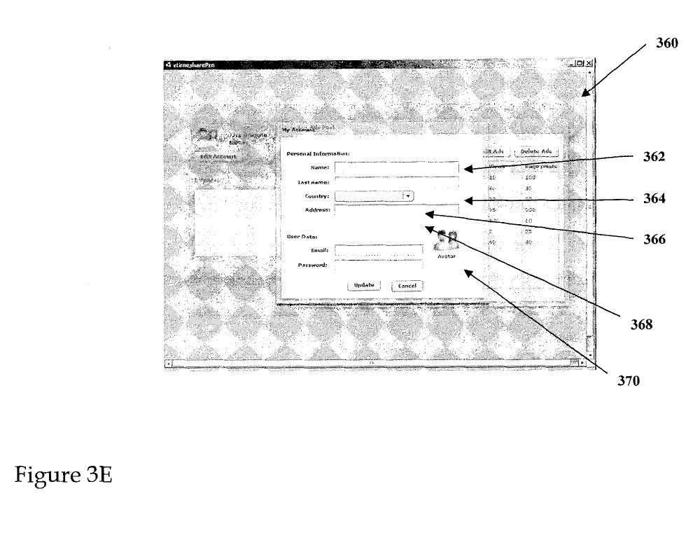

When interacting with the system, in one embodiment, seen in FIGS. 3A to 3E the user begins by having the owner of the property log onto the system screen 300 and enter their log-on information, which may be an e-mail 302 and password 304, or a user ID and password. New user's may create an account 360, and existing users may change their account information at various times. The personal information may include First Name 362, Last Name 364, Country 366, Address 368 and e-mail 370.

Once logged on, the user sees a screen 320 having a listing of the one or more properties. Note that while we speak of timeshares, there is no limitation that would prohibit the user from simply selling the unit. In one embodiment, some owners may be interested in selling the timeshare (that is, transferring outright the use of a particular week, in effect selling the timeshare 322). Additionally, the operators may have property(ies) for which they are only interested in renting 324 the particular timeshare during a period of time (be it week 23 this year, next year, or perhaps in 2021).

In one embodiment, the user can see the name of the property, price, country, category (i.e. outright sale or rental of timeshare), the number of views by various users interested in the property and the number of page prints. The number of views is a critical component of the invention, for it allows to feedback to the user/operator a measure of the interest shown on their property.

A critical embodiment of the invention may be better understood when going through the rental process. When a user decides to place an ad for a particular property 326 they select it, and decide to generate a new ad 328. The user decides if they are interested in selling or renting the property 340, price 342, Location 344, Description 346 and selected images 348 of the property grounds/rooms and specific of its features. The selected images 350 are shown in a separate folder.

In one embodiment, the system is an ad placement engine capable of generating and interacting with the various classified ads engines, servers, web-pages, etc. in placing the information selected by the user into the appropriate engine's format, as well as retrieving information about the transaction over time.

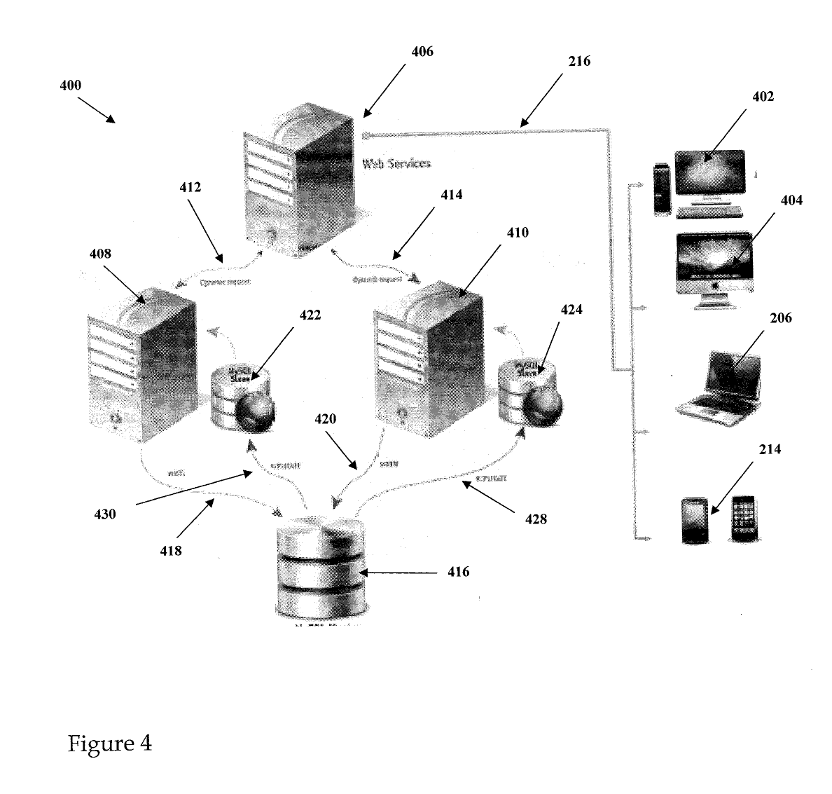

Referring to FIG. 4 in one embodiment the system 400 is comprised of one or more servers connected to one or more users. A production server 220 provides the interface to the various users of the system via the Internet 216. Said users may interact with the system via desktop 202 systems (such as PCs 402 or MACs 404), iPads/tablets/laptops 206, Cellular handsets 214 (including cellphones and Smartphones) and other portable electronic devices.

For users with a PC 402, the minimum requirements are expected to be a Windows XP, Vista or 7, with a 32-bit processor (x86) or higher, a recommended 1 GB of RAM, 600 MB of space available in the local Hard Drive (HD) and Internet access, preferably high speed. MAC 404 users are recommended to have Mac OSX 10.5 or higher, an Intel Core Duo 1.83 GHz or faster processor, 1 GB of RAM, 600 MB of HD space and an internet connection.

The production server 220 may itself be one or more computer platforms. In on embodiment, it is an Intel Core 2 Duo processor operating at 2.66 GHz speed, with 4 GB or more of DDR Ram, one or more 600 GB S-ATA II drives and one or more Local Area Network (LAN) ports, preferably Gigabit. In one embodiment, the above hardware will be executing one or more version of the CentOS 5.2 Linux OS, Apache 2.0 WebServer (such as that having the Library JavaScript Object Notation (JSON)), Database support programs (e.g. MySQL5, PHP4, CGI, Perl and/or SSI), email support clients (e.g. POP3, SMTP, IMAP and/or Webmail). In addition to the above, in one embodiment, the system will also have Mail Scanner/Virus Scanner utilities, Spam Filtering, Terminal SSH, Java SDK 6 and a bandwidth quota of 1500 GB.

Depending on load and users, the server function 220 may be split among one or more machines. In one embodiment, one machine serves as the web services server 406, and is linked via dynamic request channels (412, 414) to one or more posting ads servers 408, 410. In one embodiment, the servers are run as mirrors of each other, to minimize the effect of any failure, with one Posting Ad server 408 being the originator and the other 410 being the replicator.

A MySQL Master database 416 is referenced by both posting ad servers, with both the originator and the replicator server (408, 410) writing (418, 420) to it, and the Master SQL DB 416 replicating writes (428, 430) to the originator's DB 422 as well as the replicator's DB 424. In the above fashion, the risk of missing the posting of a client's ads (or responses to it are minimized.

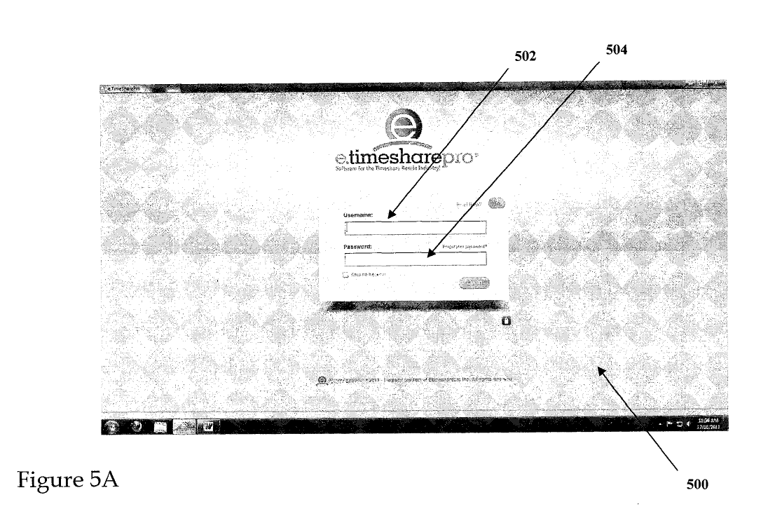

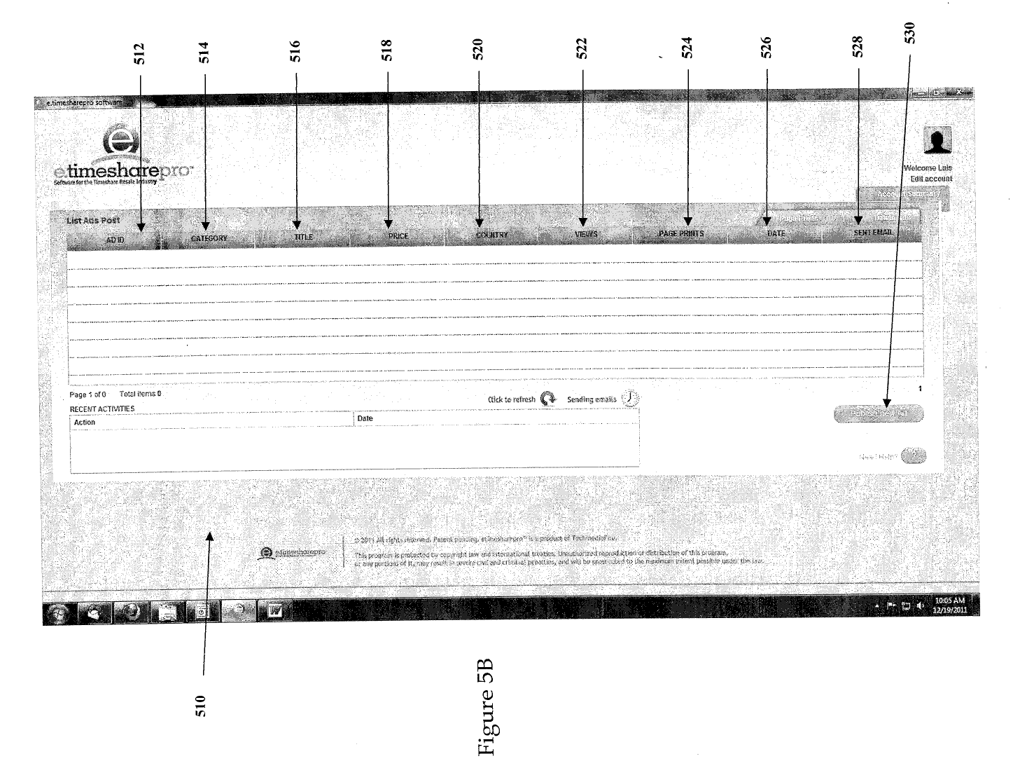

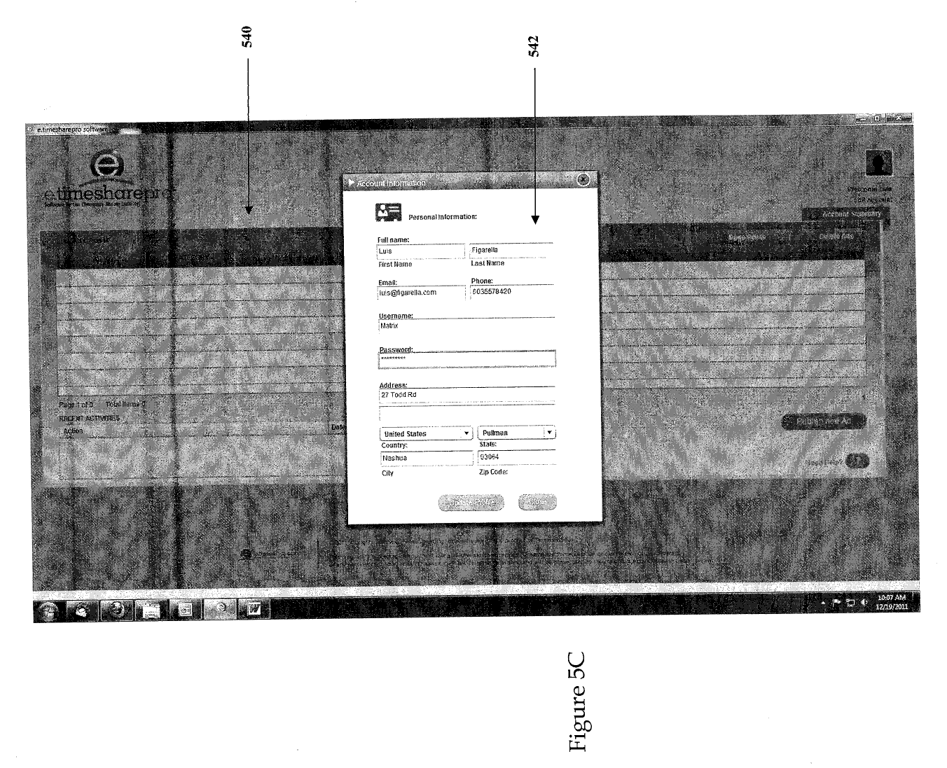

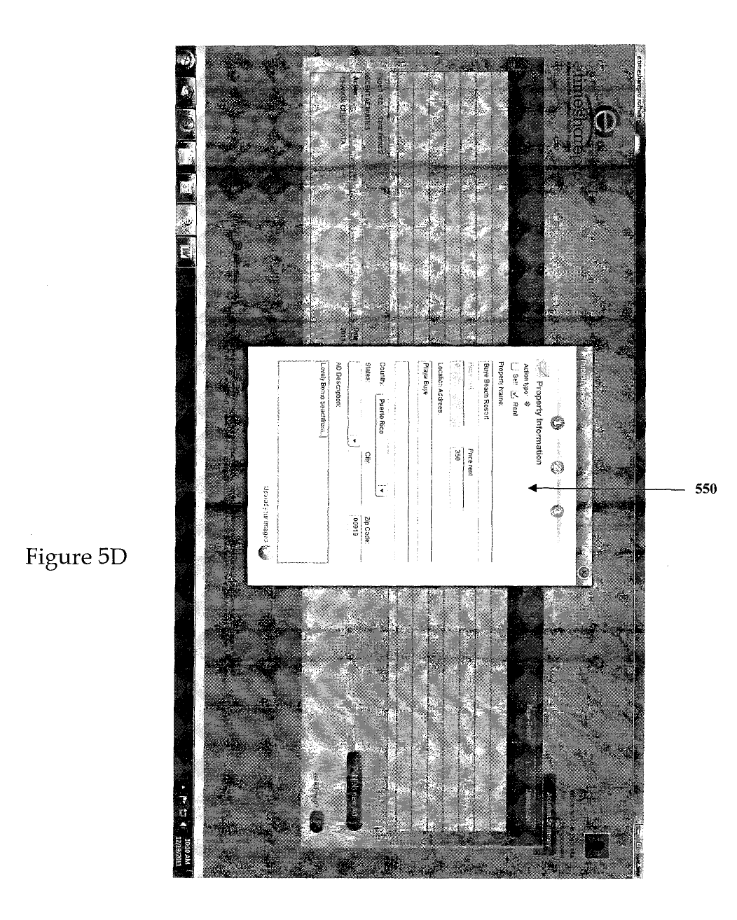

Referring to FIGS. 5A-5D, an alternate embodiment of the user screens can be seen. In this embodiment, the user software is an application meant to run on the user's computer installed via either CD/DVD/Online or other. In an alternate embodiment, the application runs within a browser. In either case, in one embodiment the initial page shows a screen 500 for the user to enter their name 502 and password 504.

To begin with, the user can see a screen 510 with the information about their placed ads which in one embodiment includes the add ID 512, the category 514, title 516, price 518, country 520, the number of views 522, page prints 524, date 526, and whether an e-mail about it was sent 528. In this fashion, a user may get a list of all interest shown in their advertised property. As seen in FIG. 5C, the user may enter their personal data 542 on the personal information screen 540. In one embodiment, when a new add is desired 530 the correct button is pressed, and a property information window 550 appears. In it, the user selects whether the property is a rental or a sale, the name, location (including country) as well as the property description.

In one embodiment, a list of possible advertisers is generated, and a drop down menu is shown to the user. In an alternate embodiment, data provided by the user is utilized to generate a series of weighs used to organize in priority the various available entities. This information includes the address of the property, the address of the owner (including street, town, postal code, country and region of the country), as well as dwelling type (Apartment, House), the name of the owner (ethnicity, male/female status).

In addition, the placement of the ad may be time sequenced to depend on the various regional variability. For example, in Southern Europe, there is no need to advertise in August, when the majority of the possible renters are on vacation, whereas in the Northeast of the USA, December is a traditional time to book the Spring-break vacation trip to Florida.

In addition to such other user supplied information, information about the user may be gleamed without the user consciously providing it. One of these is the user's DNS. Computers connected to the Internet using broadband connections usually do this via a number of gateways; a cable modem, a DSL modem, a Local Area Network (LAN) [be it wired or wireless] and a wireless 3G/4G type of cellular connection.

The function of the Internet gateway is to become the residence of a unique Internet Protocol (IP) address. This IP address is represented as a four group numerical address (in the format W.X.Y.Z where each letter represents a binary value between 0 and 255), that uniquely identifies each gateway to every other computer in the Internet. This means that the device's unique address may be used as a factor.

In another embodiment, browser cookies (or apps in the case of a smartphone or Tablet) are used to track the user's activities in Facebook, Groupon and other groupware applications, particularly those related to vacation sites.

In one embodiment, the system uses the above information about the user, to handle the placing of the ads in the one or more servers 230 running the classified ads applications for the various locations chosen. For example, if the location of the user is Eastern France, but the ISP location is seen to be Slovenia, the ads may be placed in the classified papers of Sedan, as well as in the two largest classified ad providers of Lujbiana. Similarly, if the user's location is Albuquerque, but the last name is Hispanic (say Rivera), the ad may be placed in the NM area, as well as in South Florida, Puerto Rico and New York.

Once the ads are published, the response to them may be managed in a number of ways. In its simplest embodiment, no other information (past confirmation of publication) is collected. In an alternate embodiment, the number of ‘hits’, or responses to the ad are collected from the various servers 230 running the classifieds. In this fashion, the number of responses (or views 322) per property may be logged.

In one embodiment, once the user and the renter have agreed to the rental of a particular property, the system proceeds to provide the renter with links and offers to vendors nearby. In this fashion, the renter may be provided with the link to an online supermarket nearby, or a scuba/snorkel equipment rental shop nearby. The renter could then arrange to order a list of items (both consumables and toiletries) to be delivered at the rental location (be the complex rental office and/or the property) on an appointed date. Such a service would allow renters to have the vacation basics taken care of, and spend more time at the beach.

Note that as before, in addition to add-on vendor services that are simply contracted, the URL and other privacy information from the renter and the landlord may be distilled to generate additional possible offers. One example could be dietary, based on the last name, language or country where the renter comes from, another would be suggesting various nearby restaurants, etc.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

1. A computer-based management system for routing the advertisement of a property comprising;
a database for managing one or more property offerings by an user with the authority to do so;
an internet enabled interface that would allow said user to identify the one or more properties to be offered, the conditions for their offering and a list of locations where said advertisements may be placed to be selected by said user;
an ad placement engine capable of generating and placing electronically over the Internet individual ads containing the user selected information into the one or more computer systems responsible for taking said data and generating said ads.

2. the management system of claim 1 wherein;
the list of locations presented to the user is automatically generated by the management system using information about the user that they have entered into the database.

3. the management system of claim 2 wherein;
the list of locations presented to the user is automatically generated by the management system using information about the user that may be obtained without said information's conscious entry into the system by the user.

4. The management system of claim 3 wherein;
the properties being managed are timeshares.

5. A computer based method for managing the routing of advertisements for a property comprising;
providing a database for managing one or more property offerings by an user with the authority to do so;
providing an internet enabled interface that would allow said user to identify the one or more properties to be offered, the conditions for their offering and a list of locations where said advertisements may be placed to be selected by said user;
providing an ad placement engine capable of generating and placing electronically over the Internet individual ads containing the user selected information into the one or more computer systems responsible for taking said data and generating said ads.

6. the management method of claim 5 wherein;
the list of locations presented to the user is automatically generated by the management system using information about the user that they have entered into the database.

7. the management method of claim 6 wherein;
the list of locations presented to the user is automatically generated by the management system using information about the user that is obtained without the user conscious entry into the system.

8. the management method of claim 7 wherein;
the properties being managed are timeshares.
